(19) United States
(12) Patent Application Publication
(10) Pub. No.: US 2025/0315921 A1
(43) Pub. Date: Oct. 9, 2025

(54) IMAGE PROCESSING DEVICE AND IMAGE PROCESSING METHOD

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP); NEC Corporation, Tokyo (JP)

(72) Inventors: Akira TOKUSE, Nisshin-shi (JP); Kenichi MIYAZAKI, Nisshin-shi (JP); Atsushi HATABU, Minato-ku (JP); Toshihiko NAKAMURA, Minato-ku (JP)

(21) Appl. No.: 19/052,435

(22) Filed: Feb. 13, 2025

(30) Foreign Application Priority Data
Apr. 3, 2024 (JP) 2024-059912

(51) Int. Cl. G06T 5/30; G06T 5/50; G06T 7/11; G06V 10/44; G06V 10/771

(52) U.S. Cl. CPC G06T 5/30; G06T 5/50; G06T 7/11; G06V 10/44; G06V 10/771

(57) ABSTRACT

Multiple feature points are detected from an image. A feature point score is calculated for each feature point. The feature points are thinned out using the feature point scores. In the thinning-out, (a) the image is divided into small regions. (b) Multiple combination regions are generated by combining the small regions adjacent to each other. (c) From among the feature points disposed in each combination region, feature points in descending order of feature point score are selected, and the other feature points are deleted from each combination region. A thinning-out step of processes of (b) and (c) with the combination regions as new small regions is repeated until a predetermined termination condition is met.

### CROSS REFERENCE TO RELATED APPLICATION

The present application claims the benefit of priority from Japanese Patent Application No. 2024-059912 filed on Apr. 3, 2024. The entire disclosure of the above application is incorporated herein by reference.

### TECHNICAL FIELD

The present disclosure relates to an image processing device and an image processing method that performs a process of thinning out feature points.

### BACKGROUND ART

A conceivable technique teaches an image processing device that executes a process of thinning out feature points. This image processing device divides an image into a plurality of regions, and performs thinning-out of feature points in each divided region so that the number of feature points falls within a predetermined limited number of feature points. At this time, the feature points are thinned out in ascending order of reliability.

### SUMMARY OF INVENTION

According to an example, multiple feature points are detected from an image. A feature point score is calculated for each feature point. The feature points are thinned out using the feature point scores. In the thinning-out, (a) the image is divided into small regions. (b) Multiple combination regions are generated by combining the small regions adjacent to each other. (c) From among the feature points disposed in each combination region, feature points in descending order of feature point score are selected, and the other feature points are deleted from each combination region. A thinning-out step of processes of (b) and (c) with the combination regions as new small regions is repeated until a predetermined termination condition is met.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing the configuration of an image processing device according to an embodiment;

FIG. 2 is a flowchart showing a procedure of thinning-out processing according to a first embodiment;

FIG. 3 is an explanatory diagram showing an example of a process target image;

FIG. 4 is an explanatory diagram showing an example of a feature point map including a plurality of detected feature points;

FIG. 5 is a diagram illustrating a feature point map initially divided into a plurality of small regions;

FIG. 6 is an explanatory diagram showing a feature point map after a first thinning-out step is executed;

FIG. 7 is an explanatory diagram showing a feature point map after a second thinning-out step is executed;

FIG. 8 is a block diagram showing the configuration of a thinning-out processing unit applicable to the first embodiment;

FIG. 9 is a flowchart showing a procedure of thinning-out processing according to a second embodiment;

FIG. 10 is a diagram illustrating a restored feature point map including restored small regions;

FIG. 11 is a diagram illustrating a sorting order of restored combination regions;

FIG. 12 is a diagram illustrating a feature point map after an adjusted thinning-out process;

FIG. 13 is a block diagram showing the configuration of a thinning-out processing unit applicable to the second embodiment; and

FIG. 14 is a flowchart showing a procedure of thinning-out processing according to a third embodiment.

### DETAILED DESCRIPTION

In the above-mentioned conventional technology, since the number of feature points in each divided region is set to within a limited number, it is difficult to efficiently adjust the number of feature points in the entire image. Therefore, a technique is desired that can efficiently perform thinning-out process while adjusting the number of feature points in the entire image.

According to one aspect of the present embodiments, an image processing device is provided. This image processing device includes a feature point detection unit that detects a plurality of feature points from an image, a score calculation unit that calculates a feature point score for each of the plurality of feature points, and a thinning-out processing unit that thins out the plurality of feature points using the feature point scores. The thinning-out processing unit is configured to execute: (a) dividing the image into an initial number of small regions; (b) generating a plurality of combination regions by combining the small regions having the number of “N×M” and adjacent to each other, where one of N and M is an integer equal to or greater than 1 and the other is an integer equal to or greater than 2; (c) selecting, from among the feature points disposed in each of the plurality of combination regions, feature points having the number of Q in descending order of feature point score, where Q is an integer equal to or greater than 1, and deleting the other feature points from each of the plurality of combination regions; and (d) repeating the thinning-out steps of the processes (b) and (c) with the combination regions as new small regions until a predetermined termination condition is met.

According to this image processing device, feature points are thinned out while small regions are being combined, so that thinning-out can be performed efficiently while adjusting the number of feature points in the entire image.

### A. First Embodiment

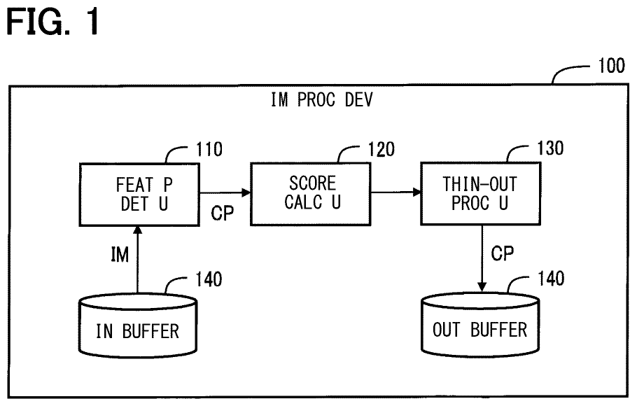

As shown in FIG. 1, the image processing device 100 of the first embodiment includes a feature point detection unit 110, a score calculation unit 120, a thinning-out processing unit 130, an input buffer 140, and an output buffer 150.

The feature point detection unit 110 executes a process of detecting a plurality of feature points CP from an image IM input from an external device via an input buffer 140. As a detection algorithm for the feature points CP, for example, Harris corner detection, Shi-Tomasi corner detection, GFTT, SIFT, SURF, FAST, AKAZE, ORB, and the like can be used. The score calculation unit 120 calculates a feature point score for each of the plurality of feature points CP. The feature point score is an index indicating the reliability of the feature point CP. As the feature point score, for example, the Harris corner score or the Shi-Tomasi corner score can be used. The thinning-out processing unit 130 thins out the plurality of feature points CP using the feature point scores. The plurality of feature points CP after the thinning-out process are output to an external device via the output buffer 150.

The image processing device 100 can be implemented as a hardware circuit. The functions of the image processing device 100 may be implemented as a computer program. That is, the functions of the image processing device 100 may be realized by the processor executing a computer program. Here, if the image processing device 100 is configured as a hardware circuit, the thinning-out process can be performed at higher speed.

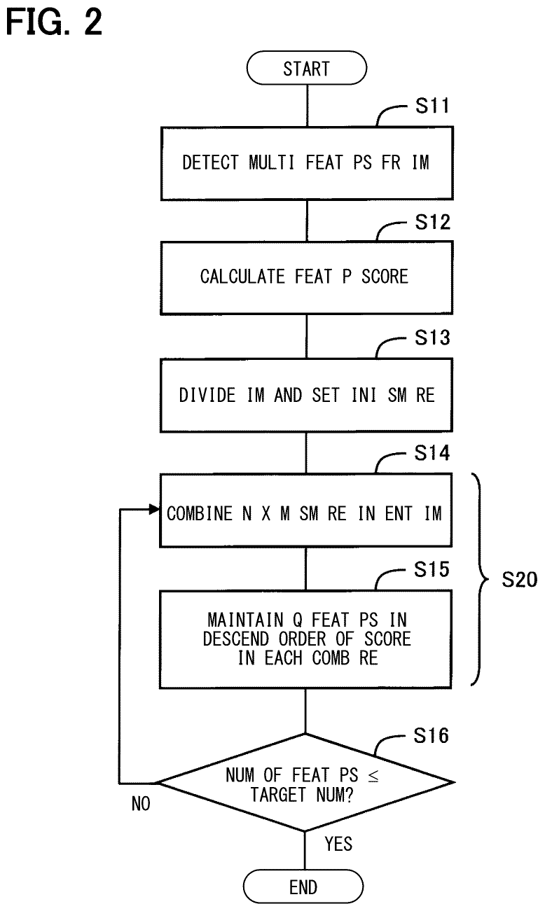

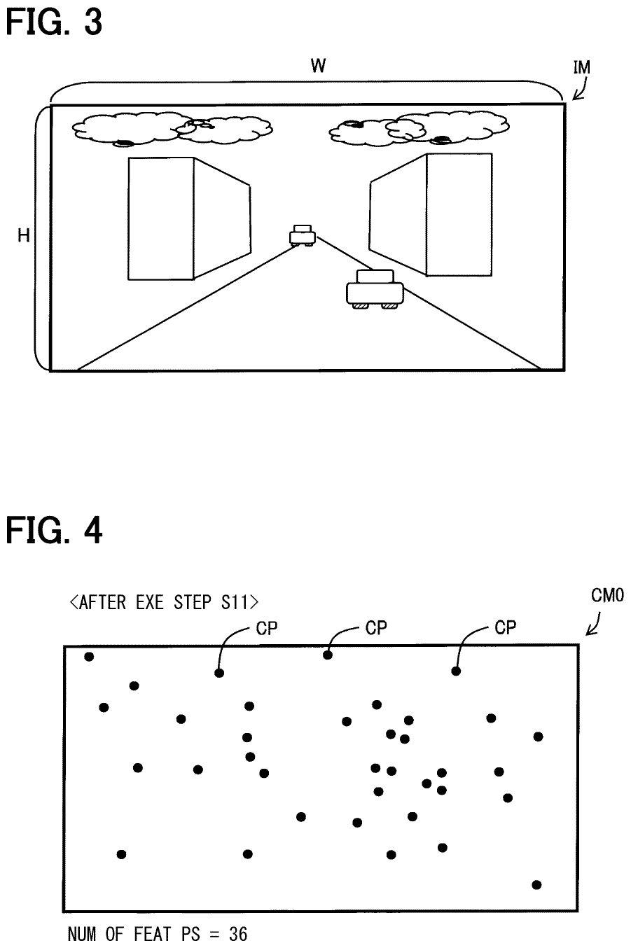

As shown in FIG. 2, in the first step S11 of the thinning-out process, the feature point detection unit 110 detects a plurality of feature points CP from the image IM. FIG. 3 shows an example of an image IM, and FIG. 4 shows a plurality of detected feature points CP. The image IM has a width of W pixels and a height of H pixels. In the example of FIG. 4, 36 feature points CP are detected in the entire image. An image area including a plurality of feature points CP is defined as a feature point map CM.” The feature point map CM has the same size as the original image IM. The “0” at the end of the reference numeral for the feature point map CM0 in FIG. 4 indicates that this is an initial map. In the following description, the feature point map CM may be referred to as an “image.”

In step S12 of FIG. 2, the score calculation unit 120 calculates a feature point score for each of the plurality of feature points CP. In step S13, the thinning-out processing unit 130 divides the image IM to set initial small regions.

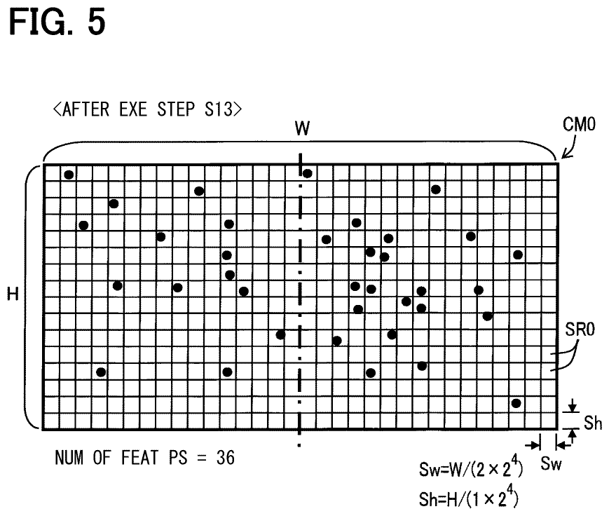

As shown in FIG. 5, when step S13 is executed, the feature point map CM0 is divided into a plurality of initial small regions SR0 of equal size. The “0” at the end of the reference numeral for the small region SR0 means that this is the initially set small region SR.

In this embodiment, the number of divisions in the width direction Dw and the number of divisions in the height direction Dh in step S13 are set according to the following expressions.

$$Dw = j \times {2}^{p} \qquad ( q1 )$$

$$Dh = k \times {2}^{p} \qquad ( q2 )$$

Here, j and k are integers of 1 or more, and p is an integer of 2 or more. Here, the integer p may be preferably 3 or more.

In the example of FIGS. 5, j=2, k=1, and p=4. When the width of the image IM is W pixels and the height is H pixels, the width Sw of the initial small region SR0 is equal to W/(2×2⁴) and the height Sh is equal to H/(1×2⁴). The dashed dotted line drawn in the center of the width direction in FIG. 5 indicates that j=2, that is, the width of the image IM is divided into two regions.

In this embodiment, in the thinning-out step described later, 2×2 small regions SR are combined to form one combination region, and thinning-out is performed within each combination region. In order to repeatedly execute such a thinning-out step, it may be preferable to set the integers j, k, and p in the above expressions (q1) and (q2) according to any one of the following setting methods.

<Method M1 for Setting Integers j, k, and p>

The width of the image IM is W pixels and the height is H pixels.

The integer p is the minimum of the largest integer n such that the expression of “2ⁿ<W” is satisfied and the largest integer m such that the expression of “2^{m}<H” is satisfied.

The integer j is the largest integer such that the expression of “j×2^{p}<W” is satisfied.

The integer k is the largest integer such that the expression of “k×2^{p}<H” is satisfied.

For example, when W=1241 and H=376, j=3, k=1, and p=8. Furthermore, when W=512 and H=512, j=2, k=2, and p=8. According to this setting method M1, the image IM can be appropriately divided so that each of the initial small regions SR0 has a size larger than one pixel and equal to or smaller than 2×2 pixels.

<Method M2 for Setting Integers j, k, and p>

The width of the image IM is W pixels and the height is H pixels.

The integer p is the minimum of the largest integer n such that the expression of “2ⁿ<=W” is satisfied and the largest integer m such that the expression of “2^{m}<=H” is satisfied.

The integer j is the largest integer such that the expression of “j×2^{p}<=W” is satisfied.

The integer k is the largest integer such that the expression of “k×2^{p}<=H” is satisfied.

This setting method M2 corresponds to setting method M1 in which the inequality sign “<” is replaced with an inequality sign with an equal sign “<=”. In this setting method M2, when W=1241 and H=376, j=3, k=1, and p=8. Furthermore, when W=512 and H=512, j=1, k=1, and p=9. According to this setting method M2, the image IM can be appropriately divided so that each of the initial small regions SR0 has a size equal to or larger than one pixel and smaller than 2×2 pixels.

<Method M3 for Setting Integers j, k, and p>

The width of the image IM is W pixels and the height is H pixels.

The integer p is the minimum value among the largest integer n such that the expression of “2ⁿ<W” is satisfied, the largest integer m such that the expression of “2^{m}<H” is satisfied, and a predetermined maximum allowable value pₘₐₓ.

The integer j is the largest integer such that the expression of “j×2^{p}<W” is satisfied.

The integer k is the largest integer such that the expression of “k×2^{p}<H” is satisfied.

This setting method M3 is obtained by adding a maximum allowable value pₘₐₓ as a candidate value for the integer p to the above-mentioned setting method M1. According to this setting method M3, the image IM can be appropriately divided so that the number of thinning-out steps does not become excessively large.

<Method M4 for Setting Integers j, k, and p>

The width of the image IM is W pixels and the height is H pixels.

The integer p is the minimum value among the largest integer n such that the expression of “2ⁿ<=W” is satisfied, the largest integer m such that the expression of “2^{m}<=H” is satisfied, and a predetermined maximum allowable value pₘₐₓ.

The integer j is the largest integer such that the expression of “j×2^{p}<=W” is satisfied.

The integer k is the largest integer such that the expression of “k×2^{p}<=H” is satisfied.

This setting method M4 is obtained by adding a maximum allowable value pₘₐₓ as a candidate value for the integer p to the above-mentioned setting method M2. According to this setting method M4, the image IM can be appropriately divided so that the number of thinning-out steps does not become excessively large.

In the above-mentioned setting methods M1 and M2, it is possible to divide the image using division numbers Dw=j×2^{p}, Dh=k×2^{p} so that the size of the divided small region SR0 is greater than or equal to 1 pixel and less than or equal to 2×2 pixels. In this embodiment, the above setting method M2 is used as an example.

Steps S14 and S15 in FIG. 2 are processes for thinning out the feature points CP, which are executed by the thinning-out processing unit 130. Hereinafter, these two steps S14 and S15 will be collectively referred to as “thinning-out step S20.”

In step S14, the thinning-out processing unit 130 generates one combination region by combining N×M small regions SR that are adjacent to each other for the entire image. One of N and M is an integer of 1 or more, and the other is an integer of 2 or more. In the present embodiment, N=M=2 is used. That is, adjacent 2×2 small regions SR are combined to generate one combination region.

The above-mentioned expressions (q1) and (q2) represent the number of divisions in the width direction Dw and the number of divisions in the height direction Dh in case of N=M=2. A generalized expression taking into consideration cases other than N=M=2 is as follows:

$$Dw = j \times {N}^{p} \qquad ( q3 )$$

$$Dh = k \times {M}^{p} \qquad ( q4 )$$

Here, j and k are integers of 1 or more, and p is an integer of 2 or more. Here, the integer p may be preferably 3 or more.

When these equations (q3) and (q4) are used, the above-mentioned methods M1 to M4 for setting the integers j, k, and p can be similarly applied. Here, in setting method M1, it may be preferable to replace the expressions of “2ⁿ<W”, “2^{m}<H”, “j×2ⁿ<W”, and “k×2^{m}<H” with the expressions of “Nⁿ<W”, “M^{m}<H”, “j×Nⁿ<W”, and “k×M^{m}<H”, respectively. The other setting methods M2 to M4 are similar. Furthermore, by generalizing the setting methods M1 and M2 to include cases other than M=N=2, the image can be divided using the division numbers Dw=j×N^{p}, Dh=k×M^{p} so that the size of the small region SR0 after division is greater than or equal to 1 pixel and less than or equal to N×M pixels. As described above, in this embodiment, M=N=2.

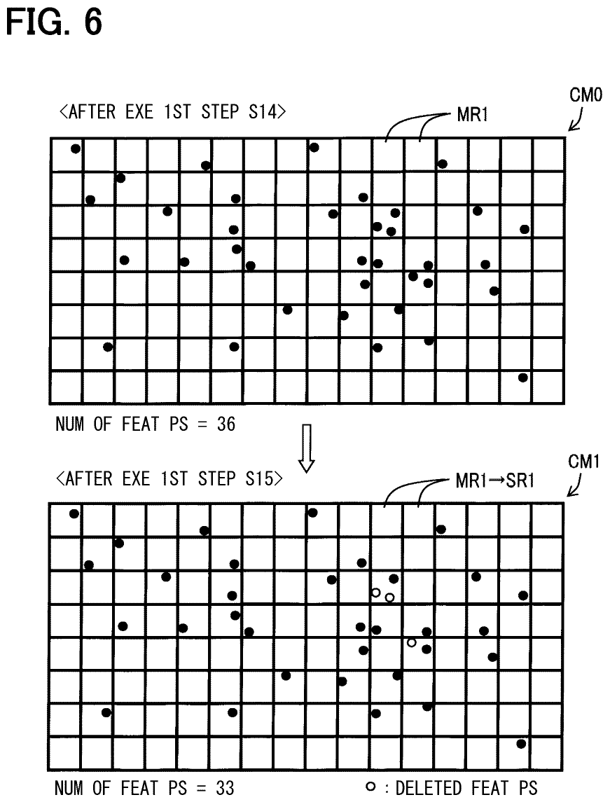

As shown in FIG. 6, in the first step S14, the small regions SR0 shown in FIG. 5 are combined in groups of 2×2 small regions to generate a combination region MR1. In the feature point map CM0 of FIG. 5, the entire image is equally divided into division numbers Dw and Dh given by the above expressions (q1) and (q2), so that 2×2 small regions SR0 can be efficiently combined in the entire image.

In step S15, the thinning-out processing unit 130 maintains Q feature points CP in descending order of feature point score in each combination region MR1, and deletes the other feature points. Q is an integer of 1 or more. In the present embodiment, Q=1 is used. That is, in each combination region MR1, one feature point CP having the highest feature point score is selected, and the other feature points are deleted. As shown in FIG. 6, after the first execution of step S15, three feature points CP are deleted, the number of feature points in the entire image is 33. The “1” at the end of the reference numeral of this feature point map CM1 indicates that this is the feature point map CM after the first thinning-out step S20 has been executed. The combination region MR1 of this feature point map CM1 is used as a small region SR1 in a second thinning-out step S20, which will be described later.

In step S16 in FIG. 2, the thinning-out processing unit 130 determines whether the number of feature points has become equal to or less than a target number. In this embodiment, the target number is 30. In the example of FIG. 6, the number of feature points is 33, which is larger than the target number, so the process returns to step S14 and the thinning-out step S20 is executed again.

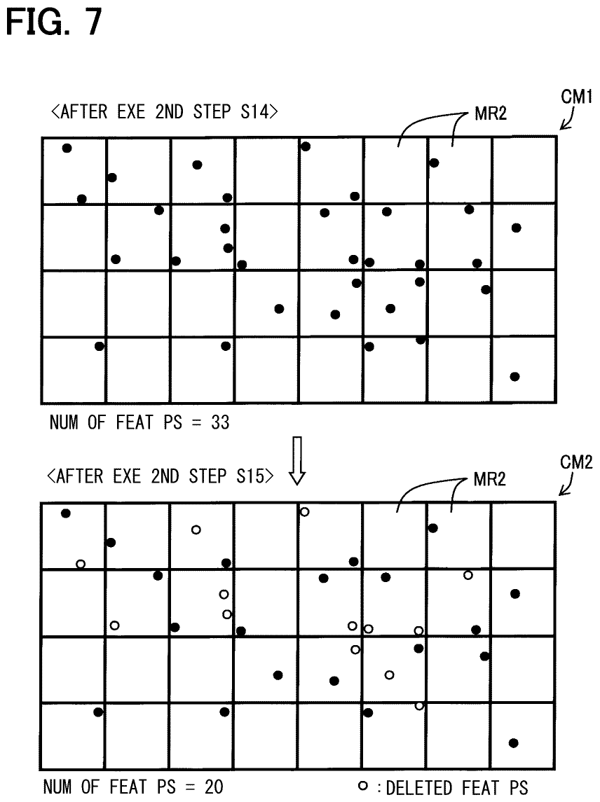

As shown in FIG. 7, in the second step S14, the small regions SR1 shown in FIG. 6 are combined in groups of 2×2 small regions to generate a combination region MR2. In the second step S15, in each combination region MR2, one feature point CP having the highest feature point score is maintained, and the other feature points are deleted. The feature point map CM2 thus obtained has 20 feature points.

In the determination in step S16 after the second execution of step S15, the number of feature points is 20, which is less than the target number of 30, so the process in FIG. 2 is terminated.

The termination condition for the thinning-out process may be a condition different from the termination condition used in step S16. For example, it is possible to use a termination condition that “the thinning-out step S20 has been executed a predetermined number of times.” In addition, a termination condition may be used in which either a first condition, that is, “the number of feature points is equal to or less than a first target number,” or a second condition, that is, “the number of feature points is equal to or less than a second target number, and a predetermined number of region combining have been performed,” is satisfied. In this case, it may be preferable that the second target number is set to a value larger than the first target number. In addition, in these various termination conditions, the “number of non-empty regions” may be used instead of the “number of feature points”. Here, a “non-empty region” refers to a small region or a combination region that includes one or more feature points CP.

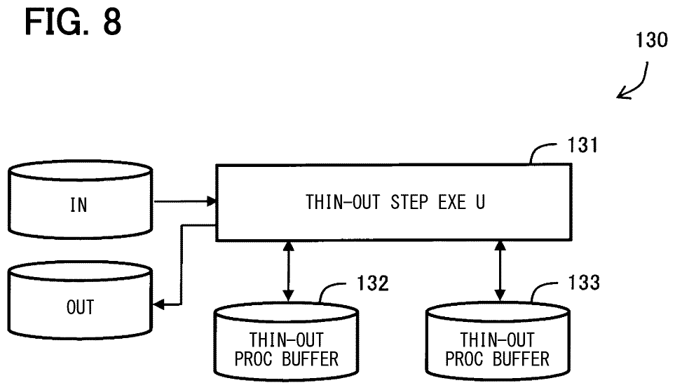

As shown in FIG. 8, the thinning-out processing unit 130 may be configured to include a thinning-out step execution unit 131 and two thinning-out processing buffers 132 and 133. Each of the thinning-out processing buffers 132 and 133 is a buffer memory. The thinning-out step execution unit 131 executes the thinning-out step S20 by alternately using the two thinning-out processing buffers 132 and 133. That is, in one thinning-out step S20, data is read from one thinning-out processing buffer and the result is written to the other thinning-out processing buffer. By using such a configuration, the thinning-out process can be efficiently performed using two buffer memories. The configuration shown in FIG. 8 is suitable for implementing the thinning-out processing unit 130 as a hardware circuit.

The plurality of feature points CP as the final processing result of the thinning-out process can be read out from either of the two thinning-out process buffers 132 and 133 and output to an external device. For example, when the final processing result is stored in the first thinning-out processing buffer 132, the plurality of feature points CP stored in this first thinning-out processing buffer 132 may be output to an external device. Alternatively, among the processing results stored in the two thinning-out processing buffers 132 and 133, the processing result with the number of feature points closest to the target number may be output to an external device.

According to the first embodiment described above, the thinning-out step S20 of combining a plurality of small regions SR and deleting some of the feature points CP is repeatedly performed, so that thinning-out can be performed efficiently while adjusting the number of feature points in the entire image.

### B. Second Embodiment

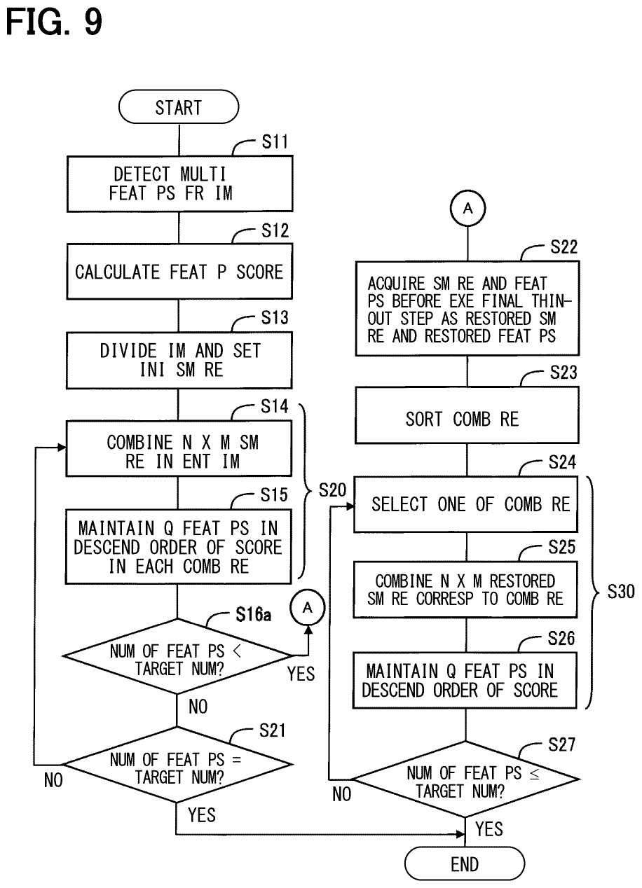

In the thinning out procedure shown in FIG. 9, step S16 in FIG. 2 is changed to step S16a, and steps S21 to S27 are added thereafter, while the other steps are the same as those in the first embodiment. The overall configuration of the image processing device 100 shown in FIG. 1 can also be applied to the second embodiment.

In step S16a, the thinning-out processing unit 130 determines whether the number of feature points is less than a target number. In the second embodiment, the target number is set to 30, similarly to the first embodiment. If the number of feature points is less than the target number, the process proceeds to step S22, which will be described later. On the other hand, if the number of feature points is equal to or greater than the target number, the process proceeds to step S21.

In step S21, the thinning-out processing unit 130 determines whether the number of feature points is equal to a target number. If the number of feature points is equal to the target number, the process of FIG. 9 ends. On the other hand, if the number of feature points is not equal to the target number, the number of feature points is greater than the target number, so the process returns to step S14, and the processes from step S14 are executed again.

As shown in FIG. 7, in the feature point map CM2 after the second execution of step S15, the number of feature points is 20, which is less than the target number, so the process proceeds from step S16a to step S22.

In step S22, the thinning-out processing unit 130 acquires the small regions SR and the feature points CP before the final thinning-out step S20 is executed as restored small regions and restored feature points. The prefix “restored” means that the result is a processing result before one thinning-out step S20 is performed. For example, if the processing result before the execution of the final thinning-out step S20 is the feature point map CM1 shown in the lower part of FIG. 6 described above, a plurality of small regions SR1 and a plurality of feature points CP included in that feature point map CM1 are acquired as restored small regions and restored feature points, respectively. For example, when the feature point map CM1 is stored in the first thinning-out processing buffer 132 of the two thinning-out processing buffers 132, 133 shown in FIG. 8, a plurality of restored small regions and a plurality of restored feature points can be acquired by reading out a plurality of small regions SR1 and a plurality of feature points CP from the first thinning-out processing buffer 132.

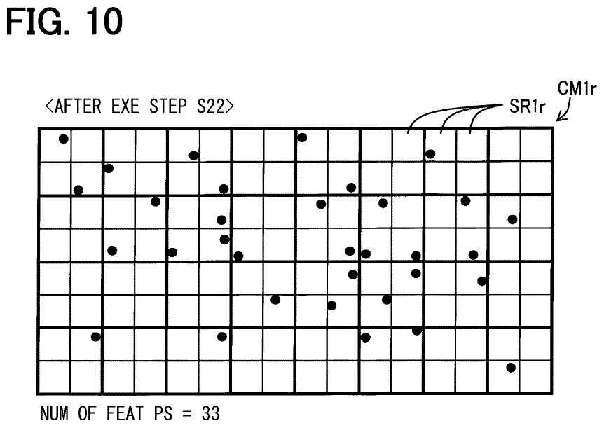

As shown in FIG. 10, a restored feature point map CM1r formed of a plurality of restored small regions SR1r has the same configuration as the feature point map CM1 shown in FIG. 6.

In step S23, the thinning-out processing unit 130 sorts the plurality of combination regions MR after the last process in step S14 in order of the number of feature points CP. For example, when step S23 is executed after the second thinning-out steps S14 and S15 shown in FIG. 7 are executed, sorting is executed on the plurality of combination regions MR2 in FIG. 7. In this embodiment, the sorting may be preferably performed in ascending order of the number of feature points CP. The reason for this is to delete the feature points CP that exist in portions with few feature points CP, and to maintain portions where the feature points CP are concentrated as much as possible. The combination region MR2 as a sorting target corresponds to a plurality of combination regions after the final thinning-out step. These combination regions MR2 can be read out, for example, from the second thinning-out buffer 133.

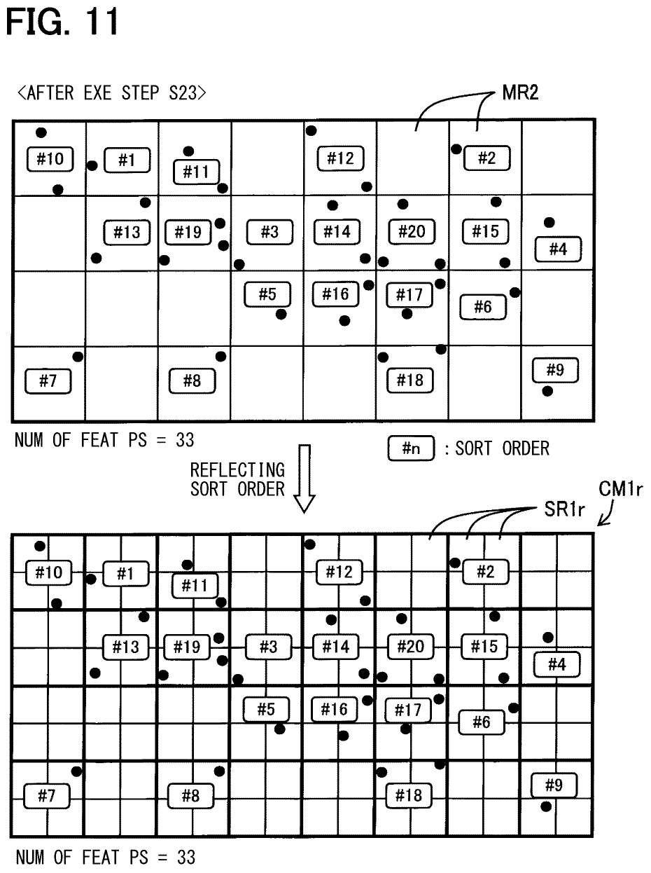

In the example of FIG. 11, a plurality of combination regions MR2 are sorted in ascending order of the number of feature points CP. Here, a combination region MR2 in which no feature point CP exists is excluded from the sorting. The numbers “#1” to “#20” assigned to each of the combination regions MR2 are ordinal numbers indicating the sorting order. The sorting order of the combination regions MR2 having the same number of feature points CP is determined according to a predetermined scanning order. In the example at the bottom of FIG. 11, for the sake of explanation, the sorting order of the combination region MR2 is added to a restored feature point map CM1r including a plurality of restored small regions SR1r.

Steps S24 to S26 in FIG. 9 are adjusted thinning-out steps executed by the thinning-out processor 130. Hereinafter, these three steps S24 to S26 will be collectively referred to as “adjusted thinning-out step S30.”

In step S24, the thinning-out unit 130 selects one combination region MR2 (in FIG. 11). The selection of the combination region MR2 may be preferably performed in the sorting order acquired in step S23. Here, the combination region MR2 may be selected randomly. The combination regions MR2 may also be selected according to the order of their sequences. When the combination region MR2 is selected without using the sort order, the above-mentioned step S23 can be omitted.

In step S25, the thinning-out processor 130 combines N×M restored small regions SR1r (in FIG. 11) corresponding to the selected combination region MR2. In the second embodiment, N=M=2 is used as in the first embodiment.

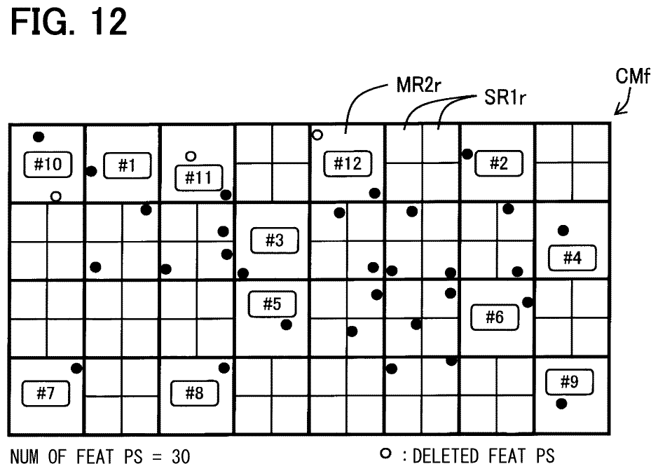

In step S26, the thinning-out processing unit 130 maintains Q feature points CP in descending order of score for a restored combination region MR2r (in FIG. 12) formed by combining the N×M restored small regions SR1r, and deletes the other feature points CP. In the second embodiment, Q=1 is used as in the first embodiment.

Here, the difference is that the thinning-out step S20 constituting steps S14 and S15 is performed on the entire image, whereas the adjusted thinning-out step S30 constituting steps S24 to S26 is performed on a set of N×M restored small regions SR1r. In this adjusted thinning-out step S30, local adjustment can be performed so that the number of feature points approaches a target number.

In step S27, the thinning-out processing unit 130 determines whether the number of feature points has become equal to or less than a target number. In the second embodiment, the target number is set to 30, similarly to the first embodiment. If the number of feature points is greater than the target number, the process returns to step S24, and the adjusted thinning-out step S30 is executed again. When the number of feature points becomes equal to or less than the target number, the process of FIG. 9 ends.

As shown in FIG. 12, in the feature point map CMf after the processing of FIG. 9 is completed, the combining of restored small regions SR1r and the deletion of feature points CP have been performed for the 12 combination regions MR2 up to #12 in the sorting order. As a result, the number of feature points is equal to the target number of 30. The regions constituting the feature point map CMf includes a mixture of a plurality of restored small regions SR1r and a plurality of restored combination regions MR2r.

In this way, in the second embodiment, the entire image IM is divided using multiple types of regions SR1r, MR2r of different sizes, and in each of these regions SR1r, MR2r, the feature points CP are thinned out so that the number of feature points is Q or less. As a result, the thinning-out process can be efficiently performed so that the number of feature points CP approaches the target number.

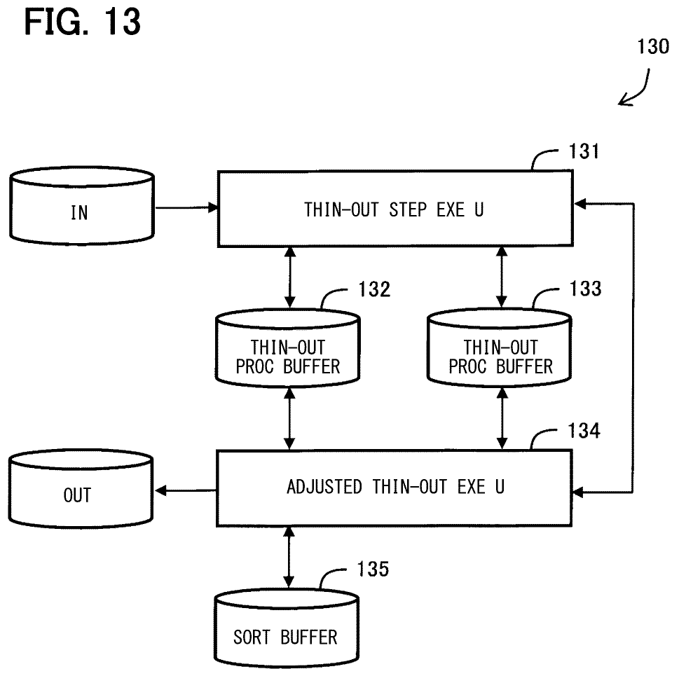

As shown in FIG. 13, the thinning-out processing unit 130 applicable to the second embodiment is obtained by adding an adjusted thinning-out execution unit 134 and a sort buffer 135 to the thinning-out processing unit 130 applicable to the first embodiment shown in FIG. 8.

The adjusted thinning-out execution unit 134 is configured to execute the processes of steps S22 to S27 in FIG. 9. The sort buffer 135 is used when executing the process of step S23. That is, the sort order of the combination regions MR determined by the sorting in step S23 is stored in the sort buffer 135. By using such a configuration, the thinning-out step S20 and the adjusted thinning-out step S30 can be efficiently performed using two buffer memories. The configuration shown in FIG. 13 is suitable for implementing the thinning-out processing unit 130 as a hardware circuit.

The second embodiment has the same advantages as those of the first embodiment. Moreover, in the second embodiment, by repeatedly executing the adjusted thinning-out step S30, it is possible to bring the number of feature points closer to the target number.

### C. Third Embodiment

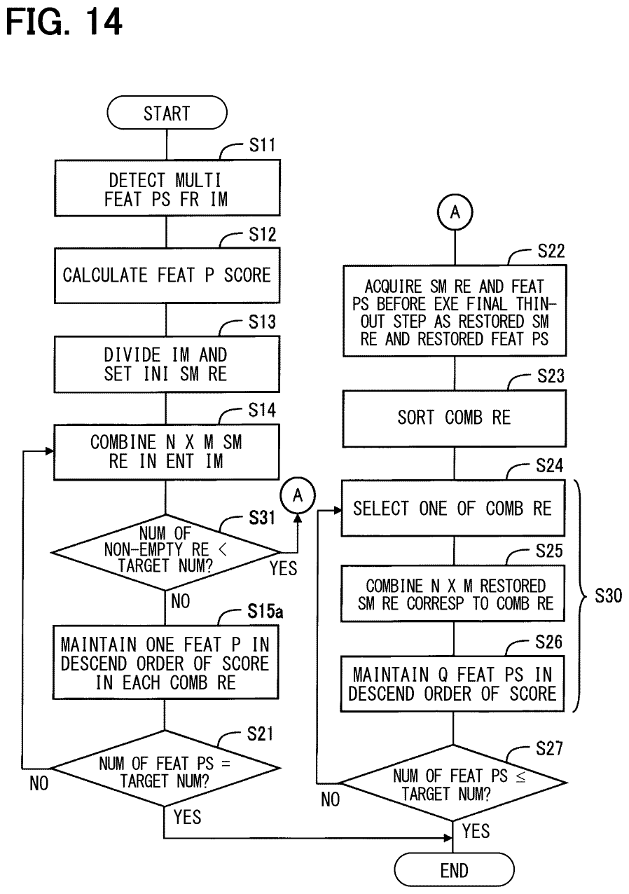

The thinning-out processing procedure shown in FIG. 14 is obtained by changing step S15 in FIG. 9 to step S15a, adding step S31 between steps S14 and S15a, and omitting step S16a in FIG. 9, while the other steps are the same as those in the second embodiment. Moreover, the overall configuration of the image processing device 100 shown in FIG. 1 and the configuration of the thinning-out processing unit 130 shown in FIG. 13 are the same as those in the second embodiment. In the third embodiment, the number Q of feature points after thinning-out in each combination region MR is set to one.

In step S31, the thinning-out processing unit 130 determines whether the number of non-empty regions is less than a target number. Here, a “non-empty region” refers to a small region SR or a combination region MR that includes one or more feature points CP. In step S31, the number of combination regions MR that include one or more feature points CP is acquired to obtain the “number of non-empty regions.” “Target number” is the target number of feature points, which is 30 in this embodiment. For example, in the feature point map CM1 after the second execution of step S14 shown in FIG. 7 described above, the number of combination regions MR2, which is the number of non-empty regions, is 20, which is less than the target number of 30.

If the number of non-empty regions is less than the target number, the process proceeds to step S22 described in the second embodiment. On the other hand, if the number of non-empty regions is equal to or greater than the target number, the process proceeds to step S15a.

In step S15a, the thinning-out processing unit 130 maintains one feature points CP in descending order of feature point score in each combination region MR1, and deletes the other feature points. This step S15a corresponds to a case where the integer Q is 1 in step S15 in FIG. 9.

In step S15a of the third embodiment, in each combination region MR, one feature point CP is maintained in descending order of feature point score and the other feature points are deleted. Therefore, the number of non-empty regions acquired in step S31 is equal to the number of feature points after execution of step S15a. Therefore, at the point of step S31 before step S15a is actually executed, it can be determined whether or not the number of feature points CP will be reduced below a predetermined target number by the processing of the thinning-out steps S14 and S15a. The other steps of the third embodiment are the same as those of the second embodiment, so the description thereof will be omitted.

The third embodiment also provides the same effects as the first and second embodiments. Furthermore, in the third embodiment, before executing step S15a for deleting the feature points CP, it is possible to determine whether the number of feature points CP will be reduced below a predetermined target number by the processing of thinning-out steps S14 and S15a, which has the advantage of being able to omit unnecessary processing.

The present disclosure is not limited to the above-described embodiment and its modifications, and can be embodied in various forms without departing from the spirit and scope of the present disclosure.

In the present disclosure, the term “processor” may refer to a single hardware processor or several hardware processors that are configured to execute computer program code (i.e., one or more instructions of a program). In other words, a processor may be one or more programmable hardware devices. For instance, a processor may be a general-purpose or embedded processor and include, but not necessarily limited to, CPU (a Central Processing Circuit), a microprocessor, a microcontroller, and PLD (a Programmable Logic Device) such as FPGA (a Field Programmable Gate Array).

The term “memory” in the present disclosure may refer to a single or several hardware memory configured to store computer program code (i.e., one or more instructions of a program) and/or data accessible by a processor. A memory may be implemented using any suitable memory technology, such as static random-access memory (SRAM), synchronous dynamic RAM (SDRAM), nonvolatile/Flash-type memory, or any other type of memory. Computer program code may be stored on the memory and, when executed by a processor, cause the processor to perform the above-described various functions.

In the present disclosure, the term “circuit” may refer to a single hardware logical circuit or several hardware logical circuits (in other words, “circuitry”) that are configured to perform one or more functions. In other words (and in contrast to the term “processor”), the term “circuit” refers to one or more non-programmable circuits. For instance, a circuit may be IC (an Integrated Circuit) such as ASIC (an application-specific integrated circuit) and any other types of non-programmable circuits.

In the present disclosure, the phrase “at least one of (i) a circuit and (ii) a processor” should be understood as disjunctive (logical disjunction) where the circuit and the processor can be optional and not be construed to mean “at least one of a circuit and at least one of a processor”. Therefore, in the present disclosure, the phrase “at least one of a circuit and a processor is configured to cause an image processing device to perform functions” should be understood that (i) only the circuit can cause an image processing device to perform all the functions, (ii) only the processor can cause an image processing device to perform all the functions, or (iii) the circuit can cause an image processing device to perform at least one of the functions and the processor can cause an image processing device to perform the remaining functions. For instance, in the case of the above-described (iii), function A and B among the functions A to C may be implemented by a circuit, while the remaining function C may be implemented by a processor.

It is noted that a flowchart or the processing of the flowchart in the present application includes sections (also referred to as steps), each of which is represented, for instance, as S11. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An image processing device comprising:
a feature point detection unit that detects a plurality of feature points from an image;
a score calculation unit that calculates a feature point score for each of the plurality of feature points; and
a thinning-out processing unit that thins out the plurality of feature points using the feature point scores, wherein:
the thinning-out processing unit is configured to execute:
(a) dividing the image into an initial number of small regions;
(b) generating a plurality of combination regions by combining the small regions having a numerical number of “N×M” and adjacent to each other, where one of N and M is an integer equal to or greater than 1 and the other is an integer equal to or greater than 2;
(c) selecting, from among the feature points disposed in each of the plurality of combination regions, feature points having a numerical number of Q in descending order of feature point score, where Q is an integer equal to or greater than 1, and deleting the other feature points from each of the plurality of combination regions; and
(d) repeating a thinning-out step of processes of (b) and (c) with the plurality of combination regions as new small regions until a predetermined termination condition is met.

2. The image processing device according to claim 1, wherein:
a process of (a) includes a process of setting the plurality of initial small regions by dividing a height and a width of the image using a division number Dw in a width direction of the image and a division number Dh in a height direction of the image, respectively;
j and k are integers of 1 or more, and p is an integer of 2 or more; and
Dw=j×N^{p} and Dh=k×M^{p}.

3. The image processing device according to claim 2, wherein:
each of the integers N and M are 2, and the integer Q is 1; and
Dw=j×2^{p} and Dh=k×2^{p}.

4. The image processing device according to claim 3, wherein:
the width of the image is defined as W pixels and the height of the image is defined as H pixels;
the integer p is a minimum value among a plurality of candidate values including a maximum integer n such that an expression of “2ⁿ<W” is satisfied, and a maximum integer m such that an expression of “2^{m}<H” is satisfied; and
the integer j is a largest integer such that an expression of “j×2^{p}<W” is satisfied, and the integer k is a largest integer such that an expression of “k×2^{p}<H” is satisfied.

5. The image processing device according to claim 3, wherein:
the width of the image is defined as W pixels and the height of the image is defined as H pixels;
the integer p is a minimum value among a plurality of candidate values including a maximum integer n such that an expression of “2ⁿ<=W” is satisfied, and a maximum integer m such that an expression of “2^{m}<=H” is satisfied; and
the integer j is a largest integer such that an expression of “j×2^{p}<=W” is satisfied, and the integer k is a largest integer such that an expression of “k×2^{p}<=H” is satisfied.

6. The image processing device according to claim 4, wherein:
the plurality of candidate values further includes a predetermined maximum allowable value.

7. The image processing device according to claim 1, wherein:
when a numerical number of the feature points remaining in an entire image becomes smaller than a predetermined target number by a final thinning-out step which is the thinning-out step of processes (b) and (c) executed last, the thinning-out processing unit is configured to execute:
(e1) acquiring the plurality of small regions and the plurality of feature points before the final thinning-out step as a plurality of restored small regions and a plurality of restored feature points;
(e2) selecting one of the plurality of combination regions after the final thinning-out step;
(e3) generating a new combination region by combining N×M restored small regions corresponding to a selected one of the plurality of combination regions;
(e4) selecting Q restored feature points from the restored feature points disposed in the new combination region in descending order of feature point score and deleting other restored feature points from the new combination region; and
(e5) repeating processes of (e2) to (e4) until a remaining numerical number of the restored feature points becomes equal to or less than the target number.

8. The image processing device according to claim 7, wherein:
the thinning-out processing unit includes two buffer memories for storing the plurality of small regions; and
in the process of (b) in the thinning-out step, the N×M small regions before combining the N×M restored small regions are read out from one of the two buffer memories, and the new combination region after combining the N×M restored small regions is written to the other of the two buffer memories.

9. The image processing device according to claim 8, wherein:
the thinning-out processing unit is configured to execute:
the process of (e1) by reading the plurality of small regions from a first buffer memory, which is one of the two buffer memories and was used for the reading out of the N×M small regions in the final thinning-out step;
the selecting of the one of the plurality of combination regions in the process of (e2) using the plurality of combination regions stored in a second buffer memory of the two buffer memories; and
the processes of (e3) to (e5) by reading out the N×M restored small regions corresponding to a selected one of the plurality of combination regions from the first buffer memory.

10. The image processing device according to claim 1, further comprising:
at least one of (i) a circuit and (ii) a processor having a memory storing computer program code, wherein:
the at least one of the circuit and the processor having the memory is configured to cause the image processing device to provide at least one of: the feature point detection unit; the score calculation unit; and the thinning-out processing unit.

11. An image processing method comprising:
detecting a plurality of feature points from an image;
calculating a feature point score for each of the plurality of feature points;
thinning out the plurality of feature points using the feature point scores, wherein:
the thinning-out of the plurality of feature points includes:
(a) dividing the image into an initial number of small regions;
(b) generating a plurality of combination regions by combining the small regions having a numerical number of “N×M” and adjacent to each other, where one of N and M is an integer equal to or greater than 1 and the other is an integer equal to or greater than 2;
(c) selecting, from among the feature points disposed in each of the plurality of combination regions, feature points having a numerical number of Q in descending order of feature point score, where Q is an integer equal to or greater than 1, and deleting the other feature points from each of the plurality of combination regions; and
(d) repeating a thinning-out step of processes of (b) and (c) with the plurality of combination regions as new small regions until a predetermined termination condition is met.
